(19) United States
(12) Patent Application Publication
(10) Pub. No.: US 2010/0177529 A1
(43) Pub. Date: Jul. 15, 2010

(54) AUTOMOBILE BRAKE LAMP

(76) Inventor: Jyoshin SHIMIZU, Marugame-Shi (JP)

Correspondence Address: BACON & THOMAS, PLLC, 625 SLATERS LANE, FOURTH FLOOR, ALEXANDRIA, VA, 22314-1176, US

(21) Appl. No.: 12/652,183

(22) Filed: Jan. 5, 2010

(30) Foreign Application Priority Data
Jan. 13, 2009 (JP) 2009-004188

(51) Int. Cl. B60Q 1/26

(52) U.S. Cl. 362/541

(57) ABSTRACT

An automobile brake lamp for an automobile having a front portion, a brake and a brake pedal adapted to actuate the brake to decelerate the automobile when depressed, the brake lamp being mounted on the front portion of the automobile in a position that is visible from the front of the automobile, and the automobile brake lamp being configured to illuminate when the brake pedal is depressed so that pedestrians who are positioned in front of the automobile may aware whether or not the automobile is braking.

### CROSS-REFERENCE TO RELATED APPLICATION

This application claims, under 35 USC 119, priority of Japanese Patent Application No. 2009-004188, filed Jan. 13, 2009 disclosure of which, inclusive of the specification, claims and drawings, is hereby incorporated by reference herein.

### BACKGROUND OF THE INVENTION

1. Field of the invention

The present invention relates to an automobile brake lamp, and more particularly, to an automobile brake lamp which is easily visible from the front of the automobile.

2. Description of Prior Art

In general, automobiles are equipped with brake lamps (brake lights) at the rear which illuminate when the brake pedal is depressed (see JP-A-H11-278150, for example).

The brake lamps are mounted in positions that are clearly visible from the rear of the automobile and illuminate to warn the driver of the following automobile that the leading automobile is braking.

However, since brake lamps are provided only at the rear of automobiles, they cannot send any signal to those who are in front of the automobiles.

### SUMMARY OF THE INVENTION

The present invention has been made in view of the above circumstances, and it is, therefore, an object of the present invention to provide means for informing those who are in front of an automobile that the automobile is braking and will stop.

A first aspect of the present invention provides, as first means to solve the problem, an automobile brake lamp for an automobile having a front portion and a brake pedal adapted to actuate a brake to decelerate or stop the automobile when depressed. The automobile brake lamp is mounted on the front portion of the automobile in a position that is easily visible from the front of the automobile, and is configured to illuminate when the brake pedal is depressed.

With the above configuration, the automobile brake lamp can illuminate to inform the pedestrians walking on a pedestrian crossing ahead of the automobile that the automobile will stop at the pedestrian crossing. Also, when the driver of the leading automobile checks behind while braking to slow down or stop it, the automobile brake lamp can illuminate to inform the driver of the leading automobile that the following automobile is also braking. In addition, the automobile brake lamp can illuminate to inform the drivers running on the road crossing the one on which the automobile is traveling that the driver of the automobile is driving slowly and carefully while braking. These contribute to the prevention of traffic accidents.

In a second aspect of the present invention as second means to solve the problem, the automobile is provided with a pair of right and left headlights and the automobile brake lamp is mounted immediately below each of the headlights. With this configuration, the automobile brake lamps are not highly-visible when they are off but will be easily and clearly visible from the front of the automobile when they illuminate. This further contributes to the prevention of traffic accidents.

### EFFECT OF THE INVENTION

According to the first aspect of the present invention, the automobile brake lamp is mounted on a front portion of the automobile in a position that is easily visible from the front of the automobile and is configured to illuminate when the brake pedal is depressed. Therefore, the automobile brake lamp can illuminate to inform the pedestrians walking on a pedestrian crossing ahead of the automobile that the automobile will stop at the pedestrian crossing. Also, when the driver of the leading automobile checks behind while braking to slow down or stop it, the automobile brake lamp can illuminate to inform the driver of the leading automobile that the following automobile is also braking. In addition, the automobile brake lamp can illuminate to inform the drivers running on the road crossing the one on which the automobile is traveling that the driver of the automobile is driving slowly and carefully while braking. These contribute to the prevention of traffic accidents.

According to the second aspect of the present invention, the automobile brake lamp is mounted immediately below each of the headlights. Therefore, the automobile brake lamps are not highly-visible when they are off but will be easily and clearly visible from the front of the automobile when they illuminate. This further contributes to the prevention of traffic accidents.

### BRIEF DESCRIPTION OF THE DRAWINGS

Other objects, features and advantages of the present invention will become apparent from the detailed description of the preferred embodiments of the invention, which follows, when considered in the light of the accompanying drawings, in which:

FIG. 1 is a perspective view schematically illustrating an automobile equipped with an automobile brake lamp system according to one embodiment of the present invention.

FIG. 2 is a schematic circuit diagram of the automobile brake lamp system of the above embodiment according to the present invention.

### DETAILED DESCRIPTION OF THE PREFERRED EMBODIMENTS OF THE INVENTION

A preferred embodiment of an automobile brake lamp system according to the present invention will be hereinafter described with reference to the accompanying drawings.

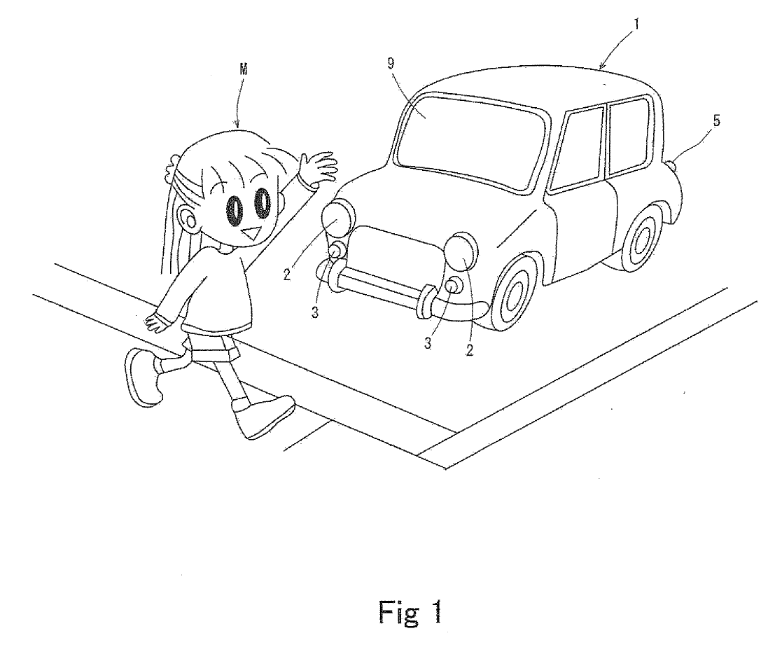

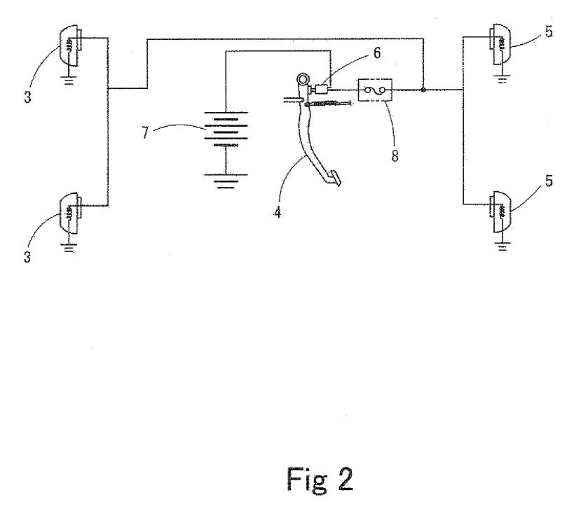

Referring to FIG. 1, the present invention is provided for an automobile 1 having a brake pedal 4 (see FIG. 2) adapted to actuate a brake of the automobile 1 to decelerate or stop the automobile 1 when depressed.

In this embodiment, a pair of front brake lamps 3 and 3 are, as shown in FIG. 1, mounted on a front portion of the automobile 1 in positions that are easily visible from the front of the automobile 1 (for example, immediately below right and left headlights 2 and 2), and are configured to illuminate when the brake pedal 4 is depressed. Although not shown in FIG. 1, the automobile also has rear brake lamps 5 and 5 mounted on a rear portion thereof as normal automobiles usually do. In FIG. 1, designated as M is a pedestrian walking on a pedestrian crossing.

FIG. 2 shows a circuit diagram of the automobile brake lamp system having the front brake lamps 3 and 3. The brake pedal 4 is provided with a brake lamp switch 6 which is turned on when the brake pedal 1 is depressed. When the brake lamp switch 6 is turned on, a current from a battery 7 is supplied to the front brake lamps 3 and 3 and the rear brake lamps 5 and 5 via a fuse 8 to illuminate both the front brake lamps 3 and 3 and the rear brake lamps 5 and 5.

With the above configuration, the front brake lamps 3 and 3 can illuminate to inform the pedestrian M walking on a pedestrian crossing ahead of the automobile 1 that the automobile 1 will stop at the pedestrian crossing. Also, when the driver of the leading automobile checks behind while braking to slow down or stop it, the front brake lamps 3 and 3 can illuminate to inform the driver of the leading automobile that the automobile 1 is also braking. In addition, the front brake lamps 3 and 3 can illuminate to inform the drivers running on the road crossing the one on which the automobile 1 is traveling that the driver of the automobile 1 is driving slowly and carefully while braking. These contribute to the prevention of traffic accidents.

When the front brake lamps 3 and 3 are located immediately below the right and left headlights 2 and 2, the front brake lamps 3 and 3 are not highly-visible when they are off but will be easily and clearly visible from the front of the automobile 1 when they illuminate. This further contributes to the prevention of traffic accidents.

It should be noted that the front brake lamps 3 and 3 may be located at any positions on a front portion of the automobile 1 as long as they are mounted in positions that are easily visible from the front of the automobile 1. For example, the front brake lamps 3 and 3 may be located near the center of the top edge or bottom edge of a windshield 9. In addition, while two front brake lamps 3 and 3 are provided in this embodiment, the number of the front brake lamps is not specifically limited. For example, only one front brake lamp may be provided at the center of a front portion of the automobile 1, or three front brake lamps may be provided, one at the center and one at each side. Moreover, the brake lamp may be composed of a plurality of small lamps, such as LEDs, arranged in any desired pattern such as a line or a circle.

The applicant of this application calls the automobile brake lamp system of this invention “eye lamp.” The term “eye lamp” means a lamp which becomes easily and clearly visible when the brake pedal of the automobile is depressed and which allows those who are in front of the automobile to determine whether or not the automobile is braking. The applicant believes that the “eye lamp” will contribute to the prevention and reduction of traffic accidents.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. An automobile brake lamp for an automobile having a front portion and a brake pedal adapted to actuate a brake to decelerate said automobile when depressed, said brake lamp being mounted on said front portion of said automobile in a position that is visible from the front of said automobile, and said automobile brake lamp being configured to illuminate when the brake pedal is depressed.

2. An automobile brake lamp according to claim 1, wherein said automobile brake lamp is composed of a plurality of small lights arranged in a given pattern.

3. An automobile brake lamp according to claim 1, wherein said automobile is provided with a pair of right and left headlights and wherein said automobile brake lamp is mounted immediately below each of said headlights.

4. An automobile brake lamp according to claim 1, wherein said automobile brake lamp is composed of a plurality of small lights arranged in a given pattern.
